(19) United States
(12) Patent Application Publication
(10) Pub. No.: US 2010/0117578 A1
(43) Pub. Date: May 13, 2010

(54) GARAGE DOOR OPENER

(76) Inventor: Robert Keith HOLLENBECK, Fort Wayne, IN (US)

Correspondence Address: General Electric Company;GE Global Patent Operation, 2 Corporate Drive, Suite 648, Shelton, CT, 06484, US

(21) Appl. No.: 12/270,448

(22) Filed: Nov. 13, 2008

(51) Int. Cl. H02P 1/04

(52) U.S. Cl. 318/461

(57) ABSTRACT

This invention relates generally to a garage door opener. The garage door opener has a user interface and an integrated motor operatively connected to the garage door. The integrated motor has a motor drive and an integrated motor control circuit. The integrated motor control circuit has a motor control microprocessor.

### BACKGROUND OF THE INVENTION

This invention relates generally to garage door openers. More particularly, this invention relates to a garage door opener with an integrated drive motor and motor controller.

Various types of automatic garage door openers have existed for many years. Conventional automatic garage door openers are electromechanical devices which raise and lower a garage door to unblock and block a garage door opening in response to actuating signals. The signals are electrical signals transmitted by closure of a push-button switch through electrical wires or by radio frequency from a battery-operated, remote controlled actuating unit. In either case the electrical signals initiate movement of the garage door from the opposite condition in which it resides. That is, if the garage door is open, the actuating signal closes it. Alternatively, when the garage door is closed, the actuating signal will open the garage door. Once movement has been initiated, the system is deactivated when the garage door movement trips a limit switch as the garage door approaches its open or closed position.

Conventional drive systems typically include either a very long worm drive or a very long drive through a chain loop tensioned between a pair of sprockets. The chain is connected to the garage door. A typical worm drive shaft is at least about eight feet in length, while the sprockets in a chain loop drive are likewise separated by a distance of at least eight feet.

When a conventional motor is activated, an instantaneously high current is usually generated. This instantaneous current spike is heavy enough to damage the motor, electronic elements of the control circuit and mechanical elements associated with the motor. One of the main limiters to life of a garage door opener is this impulse, which strikes the mechanical components of the door opener with large locked rotor torque to help break away door under frozen conditions. This impulse is applied in all conditions whether needed or not. Such motor hard start further creates distracting noise. Therefore, there is a need for an improved garage door opener.

### SUMMARY OF THE INVENTION

As described herein, embodiments of the invention overcome one or more of the above or other disadvantages known in the art.

In one aspect, this invention relates generally to a garage door opener. The garage door opener has a user interface and an integrated motor operatively connected to the garage door. The integrated motor has a motor drive and an integrated motor control circuit. The integrated motor control circuit has a motor control microprocessor.

### BRIEF DESCRIPTION OF THE DRAWINGS

The following figures illustrate examples of embodiments of the invention. In the drawings:

FIG. 1 is a perspective view of a garage door opener.

FIG. 2 is a schematic representation of an aspect of the invention integrated into the garage door opener of FIG. 1.

### DETAILED DESCRIPTION OF THE INVENTION

While the apparatus herein is described in the context of a garage door opener, as set forth more fully below, it is contemplated that the described apparatus or method may find utility in other applications. The description herein below is therefore set forth only by way of illustration rather than limitation, and is not intended to limit the practice of the herein described methods and apparatus.

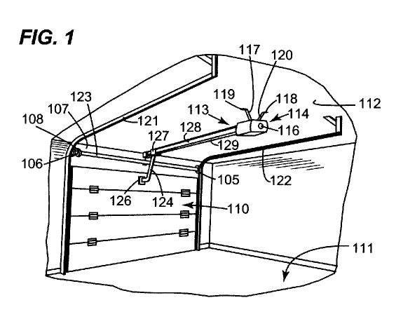

FIG. 1 illustrates a garage door opener 114 as is known in the art. Garage door opener 114 is mounted on the ceiling 112 of a garage and with a garage door 110 movably mounted on rails 121 and 122. A shaft 108 is rotatably mounted above the door 110 on the wall 107 and carries counter balance spring 123. Cables and pulleys such as the pulleys 105 and 106 are attached to the shaft 108 and the cables are connected to the door so as to spring bias it to counter balance the weight of the door in a conventional manner. The garage door opener 114 is attached to the ceiling 112 by bracket arms 117 and 118 which have portions 119 and 120 through which openings are formed to attach the door opener 114 to the ceiling 112.

The garage door operator has a main body portion 113 which may have a light 116. The motor, gear train and various electrical components are contained in the body compartment 113. A rail 128 extends from the body portion 113 and may be formed in a number of tubular sections which telescope together for support of a chain drive or other similar system or may be a treaded rod for a worm drive or similar system for opening and closing the garage door. A trolley 127 fits over the tubular rail 128 and has an arm 124 of generally L-shape which is attached to the trolley. The other end of the arm 124 is attached to a bracket 6 connected to the door 110 such that as the trolley 127 is moved relative to the rail 128, the door can be opened and closed.

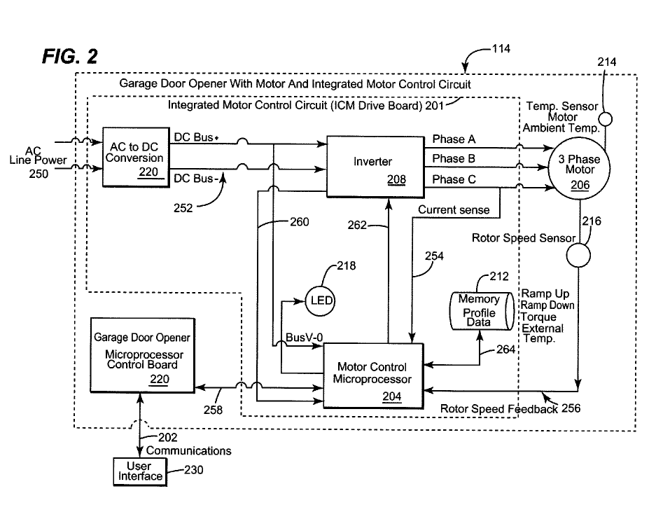

According to an aspect of the invention, as shown in FIG. 2, the main body houses the controls and operating components of the system. Line power 250, such as but not limited to 110V or 240V alternating current or AC, is supplied to the system and converted to a direct current or DC voltage in alternating current to direct current converter or AC to DC converter 210. DC bus 252 supplies the operating power to the integrated motor 201.

When a user actuates user interface 230 a signal is sent via bus 202 to the opener microprocessor control board 220 in the garage door opener 114. The opener microprocessor control board 220 communicates with the motor control microprocessor 204 in integrated motor 201 via bus 258. User interface 230 may be a remote device such as a RF remote or button or switch, or may be a human machine interface, HMI, for user control and display of system information to the user. Motor control microprocessor 204 provides a start signal to inverter 208 via bus 262. The start signal may be preprogrammed or when data is available the start signal may be provided from a memory profile 212 via bus 264.

Memory 212 contains data from previous operation of the garage door opener 114. The data stored may include, but is not limited to, operating temperature of the motor, ambient temperature, rotor speed or torque. The use of the memory profile data permits the motor control microprocessor 204 to adjust the start signal to the motor drive 206 depending on the ambient conditions. The conditions may include, door hard start, such as where the door has iced to the floor 111, operating torque, such as excess friction or during the vertical traverse as opposed to the horizontal traverse. The motor control microprocessor 204 may also utilize present operation parameters, such as the current draw of the inverter 208 via bus 254, rotor speed 216 via bus 256. These parameters are used to monitor garage door operation such as torque demand, sudden changes in torque demand and communicate this information back to the main control board to allow for condition diagnosis.

The motor control microprocessor 204 of the integrated motor 201 may determine trends in operating torques and self learn speed profiles based on the rotor revolutions of the motor drive 206 to match each individual garage door application. This would allow each application to develop on its own a unique profile based upon recorded data during operation to match motor drive 206 operation parameters to individual needs. Things like ramp up and down rates and torques could be self taught and optimized based on self learned parameters.

The motor drive 206 may be a three phase motor or any other variable speed AC or DC motor. The information relayed to the motor control microprocessor 204 could include torque, long and short term changes in torque demand for operation, and could be used for sensing broken springs, or maintenance requirements. This information may be used to assist service requirements or determine correct operation of the variable speed motor. Further, by utilizing feedback from the sensors, the torque of the motor may be incrementally increased during the start of the garage door opener until a predetermined operation speed of the motor is obtained. By incrementally increasing the torque during motor start excess noise and wear on mechanical parts will be prevented, increasing customer satisfaction and increasing reliability of the garage door opener.

A visual signal, such as a flashing light emitting diode or LED, to relay health status or serial communication status. The visual signal may also be an auditable signal or a display on an HMI device.

While the invention has been described in terms of specific embodiments, those skilled in the art will recognize that the invention can be practiced with modification within the spirit and scope of the claims in similar applications.

1. A garage door opener comprising:
a user interface;
an integrated motor operatively connected to the garage door;
the integrated motor comprising a motor drive and an integrated motor control circuit; the integrated motor control circuit comprising a motor control microprocessor.

2. The garage door opener of claim 1, wherein the integrated motor further comprises a memory; the memory comprising previous operation data.

3. The garage door opener of claim 2, wherein the integrated motor further comprises at least one sensor.

4. The garage door opener of claim 3, wherein the at least one sensor comprising at least one of motor ramp up speed, motor ramp down speed, motor temperature, ambient temperature, motor current, motor speed, or system voltage.

5. The garage door opener of claim 4, wherein the motor control microprocessor receives data from the user interface, the memory and the at least one sensor to control the motor.

6. The garage door opener of claim 1, wherein the motor drive is one of a three phase motor, a direct current motor, an alternating current motor.

7. The garage door opener of claim 1, wherein the integrated motor further comprises an alternating current to direct current converter.

8. The garage door opener of claim 1, wherein the integrated motor further comprises an inverter.

9. The garage door opener of claim 1, wherein the at least one sensor provides current operation data to the motor control microprocessor.

10. The garage door opener of claim 1, wherein the motor control microprocessor controls the torque of the motor until a predetermined operation speed is obtained.

11. The garage door opener of claim 1, wherein the user interface is at least one of a button, a remote, a human machine interface.

12. The garage door opener of claim 11, wherein the remote is a radio frequency remote.

13. The garage door opener of claim 12, wherein the human machine interface includes a display of at least one of operation data or previous operation data.

14. The garage door opener of claim 1, wherein the integrated motor further comprises a light emitting diode.
